(19) United States
(12) Patent Application Publication
(10) Pub. No.: US 2009/0237294 A1
(43) Pub. Date: Sep. 24, 2009

(54) WEIGHT CALCULATION METHOD, WEIGHT CALCULATION DEVICE, ADAPTIVE ARRAY ANTENNA, AND RADAR DEVICE

(76) Inventors: Yoshikazu SHOJI, Kawasaki-shi (JP); Junichiro Suzuki, Kawasaki-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/358,389

(22) Filed: Jan. 23, 2009

(30) Foreign Application Priority Data
Mar. 19, 2008 (JP) 2008-071578

(51) Int. Cl. G01S 13/00

(52) U.S. Cl. 342/159; 342/372

(57) ABSTRACT

A received data storage situation is monitored, and a covariance matrix Rᵢ of the i-th range cell is calculated to be temporarily stored. Covariance matrices Rᵢ of the number of training samples are called until the i becomes T from 1, covariance matrices Rᵢ are averaged by adding, and averaged covariance matrix data R^{[1]}ᵣᵣ is temporarily stored. Averaged covariance matrix data R^{[i-1]}ᵣᵣ is called until the i becomes L from 2, Rᵢ and Rᵢ₋₄ are added to the data R^{[i-1]}ᵣᵣ, Rᵢ₊₃, and Rᵢ₋₁ are subtracted from the data R^{[i-1]}ᵣᵣ, the resulting data R^{[1]}ᵣᵣ is temporarily stored, and a series of processing is terminated.

### CROSS-REFERENCE TO RELATED APPLICATIONS

This application is based upon and claims the benefit of priority from prior Japanese Patent Application No. 2008-071578, filed Mar. 19, 2008, the entire contents of which are incorporated herein by reference.

### BACKGROUND OF THE INVENTION

1. Field of the Invention

The invention relates to a weight calculation method which is appropriate to a radar device detecting a target reflection signal from a target while suppressing undesired signal by means of weight control, a weight calculation device using the weight calculation method, an adaptive array antenna with the weight calculation device adopted thereto, and a radar device with the adaptive array antenna built therein.

2. Description of the Related Art

In recent years, to improve the precision of target detection, a pulse radar device has built in an adaptive array antenna and performed the so-called adaptive null steering. The adaptive null steering applies weight control to phase and amplitude of a received signal in the adaptive array antenna and then forms a received and combined beam so as to bring directivity in direction of arrivals of undesired signal to zero (null). It is required for an adaptive array antenna to be used in such a use application to apply the weight control so as to appropriately form the received and combined beam even under an environment in which many delay signals arrive and under an environment in which clutter and undesired signal exist.

Therefore, as regards the adaptive array antenna, a weight control method, which adopts a space-time adaptive processing (STAP) (refer to J. R. Guerci, Space-Time Adaptive Processing for Radar, Arthech House, Norwood, Mass., 2003), or a multiple-input multiple-output (MIMO) radar system (refer to E. Fisher, A. Haimowich, R. Blum, L. Cimini, D. Chizhik, and R. Valenzuela, “MIMO radar: An idea whose time has come,” in Proc. IEEE Int. Radar Conf. April 2004), has been widely noticed. The STAP system is a system which has improved a signal-to-interface-plus-noise ratio (SINR) system, and the MIMO radar system is a system which has improved radar cross section (RCS) reflection characteristics through effect on angular spread due to radiation of an independent signal from each antenna to a target. Any of the systems is characterized in that an excellent beam of which the directivity in the direction of arrival of undesired signal is close to zero (null) is formed and searching performance to an RCS target is improved.

The STAP system and the MIMO radar system generally detect each target through a sliding window system as mentioned below. At first, the system receives a target reflection signal by antennas (element antennas, namely, channels) in which a multiple antenna are arranged in an array configuration, converts the received reflection signal to data for each range cell, converts the received target reflection signal into data and stores the data. The system computes a covariance matrix from the stored data, based on the range cells of the number of training samples except for range cells (processing adaptive range cells) of the cell considered to include a target signal, namely, based on the data of cell considered to be formed of only undesired signal. Finally, a beam combination circuit applies weight control to an antenna received signal by the use of the adaptive weight calculated on the basis of the computed covariance matrix.

Here, in the conventional sliding window system, it is necessary to obtain the covariance matrices of the number of training samples except for the present processing adaptive range cell for every time in weight calculation of processing adaptive range cells of all ranges. This calculation of the covariance matrices results in requirement of a large amount of computational load. Therefore, in a signal processing system by applying weight control to the adaptive array antenna to be used for the radar device of the STAP system or the MIMO radar system, when applying the sliding window system for the weight calculation to bring undesired signal directions to zero, it is needed to reduce the amount of computational load required for deriving the covariance matrix, and obtain excellent SINR characteristics in a short time.

As mentioned above, in the signal processing system by means of the weight control for the adaptive array antenna to be used for the radar device in the STAP system or the MIMO radar system, when applying the sliding window system for the weight control so as to bring undesired signal directions to zero, it is necessary to obtain the covariance matrix of the number of training samples except for the present processing adaptive range cell for every time in weight calculation of processing adaptive range cells of all ranges. Since this calculation of the covariance matrices results in requirement of a large amount of computational load, it is desired to reduce the amount of computational load.

### BRIEF SUMMARY OF THE INVENTION

An object of the invention is provide to a weight calculation method, a weight calculation device, an adaptive array antenna, and a radar device configured to store information of a covariance matrix to be derived in weight calculation for each processing adaptive range cell, successively use the information for the weight calculation to the next processing adaptive range cell, reduce the amount of computational load required to derive the covariance matrix, and also obtain excellent SINR characteristics in a short time.

According to a first aspect of a weight calculation method of the invention, there is provided a weight calculation method for use in a radar device, which stores target reflection signals of radar waves received by an antenna in corresponding cell positions along with received timing to a plurality of processing range cells each having lengths equivalent to prescribed distances on the time axis, and forms a reception combined beam so as to bring direction of arrivals of undesired signal to direction of arrivals of the target reflection signals to zero, and which calculates weights to phase and amplitude of the target reflection signals by means of a sliding window system, comprising: calculating covariance matrices of received data in all the plurality of processing range cells; storing the covariance matrices in a memory; and calculating weights for all the plurality of processing ranges by using the covariance matrices stored in the memory, wherein the calculating of the covariance matrices comprises: first processing which derives a covariance matrix to the i-th processing adaptive range cell from covariance matrices of the number of training samples to be excluded the i-th processing adaptive range cell; and second processing which derives a covariance matrix to the (i+1)-th processing adaptive range cell, by subtracting the covariance matrix to the (i+1)-th processing adaptive range cell from the previously calculated covariance matrix to the i-th processing adaptive range cell, by subtracting covariance matrices to be excluded from the training samples from the subtracting result through sliding, by adding the covariance matrix of the i-th processing adaptive range cell to the subtracting result, and by adding covariance matrices to be included in the training samples to the adding result through the sliding, and the calculating of the covariance matrices applies the first and second processing to processing adaptive range cells in all the ranges.

According to a second aspect of a weight calculation method of the invention, there is provided a weight calculation method for use in a radar device, which stores target reflection signals of radar waves received by an antenna in corresponding cell positions along with received timing to a plurality of processing range cells each having lengths equivalent to prescribed distances on the time axis, and forms a reception combined beam so as to bring direction of arrivals of undesired signal to direction of arrivals of the target reflection signals to zero, and which calculates weights to phase and amplitude of the target reflection signals by means of a sliding window system, comprising: calculating covariance matrices of received data in all the plurality of processing range cells; putting a plurality of range cells among all the range cells together as range cell groups; storing the covariance matrices for each group in a memory; and calculating weights for all the plurality of processing ranges by using the covariance matrices of each range cell group stored in the memory, wherein the calculating of the covariance matrices comprises: first processing which derives a covariance matrix to the i-th processing adaptive range cell group from covariance matrices of the number of training samples to be excluded the i-th processing adaptive range cell group; and second processing which derives a covariance matrix to the (i+1)-th processing adaptive range cell group, by subtracting the covariance matrix to the (i+1)-th processing adaptive range cell group from the previously calculated covariance matrix to the i-th processing adaptive range cell group, by subtracting covariance matrices to be excluded from the training samples from the subtracting result through sliding, by adding the covariance matrix of the i-th processing adaptive range cell group to the subtracting result, and by adding covariance matrices to be included in the training samples to the adding result through the sliding, and the calculating of the covariance matrices applies the first and second processing to processing adaptive range cell groups in all the ranges.

According to a weight calculation device of the invention, there is provided a weight calculation device comprising: storage means which stores target reflection signals of radar waves received by an antenna in corresponding cell positions along with received timing to a plurality of processing range cells each having lengths equivalent to prescribed distances on the time axis; and calculation means which calculates weights to phase and amplitude of the target reflection signals for forming a reception combined beam so as to bring direction of arrivals of undesired signal to direction of arrivals of the target reflection signals to zero by using values stored in the plurality of processing range cells, wherein the calculation means calculates weights to the phase and the amplitude of the target reflection signals by means of a sliding window system, calculates covariance matrices of received data in all the plurality of processing range cells, stores the covariance matrices in a memory, calculates weights for all the plurality of processing ranges by using the covariance matrices stored in the memory, the calculating of the covariance matrices comprises: first processing which derives a covariance matrix to the i-th processing adaptive range cell from covariance matrices of the number of training samples to be excluded the i-th processing adaptive range cell; and second processing which derives a covariance matrix to the (i+1)-th processing adaptive range cell, by subtracting the covariance matrix to the (i+1)-th processing adaptive range cell from the previously calculated covariance matrix to the i-th processing adaptive range cell, by subtracting covariance matrices to be excluded from the training samples from the subtracting result through sliding, by adding the covariance matrix of the i-th processing adaptive range cell to the subtracting result, and by adding covariance matrices to be included in the training samples to the adding result through the sliding, and the calculating of the covariance matrices applies the first and second processing to processing adaptive range cells in all the ranges.

According to an adaptive array antenna of the invention, there is provided an adaptive array antenna which arranges a plurality of element antennas in an array configuration, applies directivity control in arbitrary directions, and receives target reflection signals of radar waves, comprising: storing the target reflection signals in corresponding cell positions along with received timing to a plurality of processing range cells each having lengths equivalent to prescribed distances on the time axis; taking in adaptive weights to phase and amplitude of the received target reflection signals so as to bring direction of arrivals of undesired signal to direction of arrivals of the target reflection signals to zero; and forming a reception combined beam by applying weight control to the target reflection signals, wherein the adaptive weights are obtained by calculating weights to phase and amplitude of the received target reflection signals through a sliding window system, and are calculated for all the plurality of processing range cells by calculating covariance matrices of received data in all the plurality of processing ranges, by storing the covariance matrices in a memory, and by using the stored covariance matrices, and the calculating of the covariance matrices comprises: first processing which derives a covariance matrix to the i-th processing adaptive range cell from covariance matrices of the number of training samples to be excluded the i-th processing adaptive range cell; and second processing which derives a covariance matrix to the (i+1)-th processing adaptive range cell, by subtracting the covariance matrix to the (i+1)-th processing adaptive range cell from the previously calculated covariance matrix to the i-th processing adaptive range cell, by subtracting covariance matrices to be excluded from the training samples from the subtracting result through sliding, by adding the covariance matrix of the i-th processing adaptive range cell to the subtracting result, and by adding covariance matrices to be included in the training samples to the adding result through the sliding, and the calculating of the covariance matrices applies the first and second processing to processing adaptive range cells in all the ranges.

According to a radar device of the invention, there is provided a radar device comprising: an adaptive array antenna which arranges a plurality of element antennas in an array configuration, applies directivity control in arbitrary directions, receives target reflection signals of radar waves, applies weight control to the target reflection signals by given adaptive weights, and forms a reception combined beam; a weight calculation device which stores the target reflection signals in corresponding cell positions along with received timing to a plurality of processing range cells each having lengths equivalent to prescribed distances on the time axis, and calculates weights to phase and amplitude of the target reflection signals for forming a reception combined beam so as to bring direction of arrivals of undesired signal to direction of arrivals of the target reflection signals to zero, by using values stored in the plurality of processing range cells; and a signal processing device which detects a target from the target reflection signals to which weight control is applied by the adaptive array antenna, wherein the weight calculation means comprises: storage means which stores the target reflection signals of the radar waves received by the adaptive array antenna in corresponding cell positions in a plurality of processing range cells having lengths equivalent to prescribed distances on the time axis; and calculation means which calculates weights to phase and amplitude of the received target reflection signals for forming a reception combined beam so as to bring direction of arrivals of undesired signal to zero to direction of arrivals of the target reflection signals by using values stored in the plurality of processing range cells, wherein the calculation means calculates weights to the phase and the amplitude of the target reflection signals by means of a sliding window system, calculates covariance matrices of received data in all the plurality of processing range cells, stores the covariance matrices in a memory, calculates weights for all the plurality of processing ranges by using the covariance matrices stored in the memory, the calculating of the covariance matrices comprises: first processing which derives a covariance matrix to the i-th processing adaptive range cell from covariance matrices of the number of training samples to be excluded the i-th processing adaptive range cell; and second processing which derives a covariance matrix to the (i+1)-th processing adaptive range cell, by subtracting the covariance matrix to the (i+1)-th processing adaptive range cell from the previously calculated covariance matrix to the i-th processing adaptive range cell, by subtracting covariance matrices to be excluded from the training samples from the subtracting result through sliding, by adding the covariance matrix of the i-th processing adaptive range cell to the subtracting result, and by adding covariance matrices to be included in the training samples to the adding result through the sliding, and the calculating of the covariance matrices applies the first and second processing to processing adaptive range cells in all the ranges.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an exemplary schematic view roughly depicting a radar device to which a weight calculation method of the invention is applied;

FIG. 2 is an exemplary block diagram depicting a configuration of a received signal processing system of the radar device of FIG. 1;

FIG. 3 is an exemplary schematic view for explaining formulation of received data of the radar device shown in FIG. 1;

FIGS. 4A, 4B and 4C are exemplary views each depicting processing images of sliding windows in conventional systems;

FIG. 5 is an exemplary view depicting an aspect for storing information of a covariance matrix at each range cell in a sliding window system of the invention;

FIGS. 6A, 6B and 6C are exemplary views each depicting processing images of the sliding window systems of the invention;

FIG. 7 is an exemplary view depicting a processing image in a case in which a plurality of range cells are grouped and assumed as one processing adaptive range cell of the invention; and

FIG. 8 is an exemplary flowchart depicting a flow of concrete processing of a covariance matrix computation circuit shown in FIG. 1.

### DETAILED DESCRIPTION OF THE INVENTION

Prior to description of embodiments of the invention, processing of a sliding window system in a weight calculation method of the invention will be described.

The window system firstly receives a target reflection signal by an antenna in which a plurality (N) of antenna elements arranged in an array configuration, converts the received reflection signal into data, and stores the data. The system calculates covariance matrices of all (L) range cells from the stored data, and stores the matrices in a memory. By using the information of the stored covariance matrices, derivation of a covariance matrix for the i-th processing adaptive range cell is generated from covariance matrices of the number (T) of training samples except for the i-th processing adaptive range cell. To derive a covariance matrix for the (i+1)-th processing adaptive range cell, the system subtracts the covariance matrix of the (i+1)-th processing adaptive range cell from the covariance matrix for the previously calculated i-th processing adaptive range cell, subtracts covariance matrices to be excluded from the training samples from the subtracting result through sliding, adds the covariance matrix of the i-th processing adaptive range cell to the subtracting result, and adds covariance matrices to be included in the training samples to the adding result through the sliding. Covariance matrices for the (i+2)-th processing adaptive range cell and the (i+3)-th processing adaptive range cell are each derived in the same procedure, and finally, covariance matrices of processing adaptive range cells of all the ranges are derived.

In a case where a plurality of range cells are put together as a group, the same flow of processing is applied also in a case where the covariance matrices are stored in groups in the memory, and performs the sliding window by using the stored covariance matrix of each range cell. Then, the derivation of the covariance matrix for the i-th processing adaptive range cell group is generated from the covariance matrices of the number (T) of training samples except for the i-th processing adaptive range cell group. To derive covariance matrices for the (i+1)-th processing adaptive range cell group, the system subtracts the covariance matrices of the (i+1)-th processing adaptive range cell group from the covariance matrices for the previously calculated i-th processing adaptive range cell group, subtracts covariance matrices to be excluded from the training samples by sliding from the subtracting result through sliding, adds the covariance matrices of the i-th processing adaptive range cell group to the sliding result, and adds covariance matrices to be included in the training samples to the adding result through the sliding.

The following will describe embodiments of the invention with reference to the drawings.

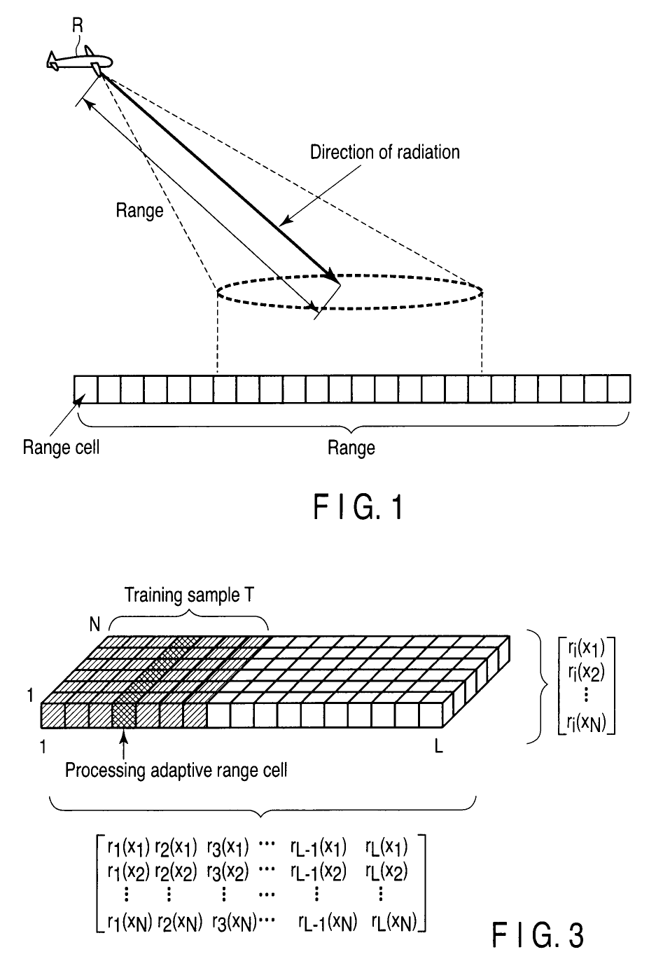

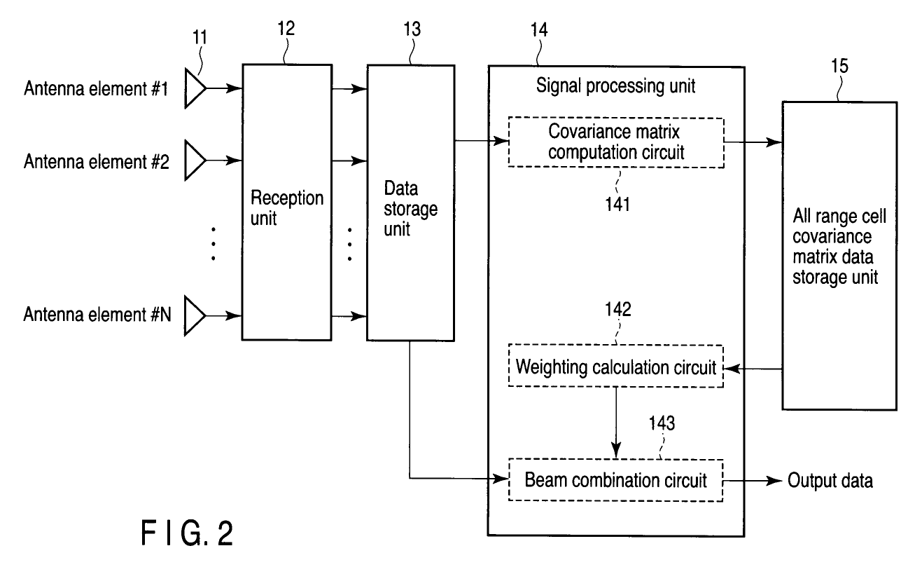

FIG. 1 depicts a schematic view depicting an outline of a radar device to which a weight calculation method of the invention is applied, and FIG. 2 is a block diagram depicting a configuration of a received signal processing system in the radar device of FIG. 1. In FIG. 1, a radar platform R mounted on the radar device radiates radar pulses toward a range to be measured from a transmit antenna, and catches a reflection wave (including a target component, a clutter component) from a target T and its circumference of the pulse by a reception antenna.

A receive antenna 11 of the radar device mounted on the radar platform R is an adaptive array antenna which sections a range direction to an radiation surface into L range cells, arranges N antenna elements #n (n=1 to N) at dx intervals from each range cell in an array configuration in a direction perpendicular to the range direction, controls a phase of each antenna element #n, and then, applies directivity control to reception beams. The received signal of the reflection wave to be captured along with the range direction by each antenna element #1-#2 is detected by a receiver 12 and supplied to a data storage unit 13. The storage unit 13 includes storage areas each corresponding to a plurality of processing range cells composed of lengths equivalent to prescribed distances on the time axis. The target reflection signals detected by the receiver 12 are stored at corresponding cell positions along with received timing. A signal processing unit 14 obtains covariance matrix data of each range cell from the storage data in the storage unit 13 by means of a covariance matrix computation circuit 141. The obtained covariance matrix data of all the range cells is stored in a storage unit 15. The signal processing unit 14 calculates weights to the processing adaptive ranges from the covariance matrix data of all the range cells stored in the storage unit 15. Further, in a beam combination circuit 143, weight is executed on the storage data in the data storage unit 13 by using the calculated weights then forms a received and combined beam so as to bring an direction of arrival of an undesired signal to zero against the direction of arrival of the target reflection signal.

The weight calculation method of the invention to be applied to the radar device configured as mentioned above will be described.

At first, the received data of the reflection wave captured by the reception antenna 11 is formulized as follows. FIG. 3 shows a schematic view for explaining the formulation of the received data in the radar device shown in FIG. 1, and illustrates the configuration of the received data in a case in which each element position of the array antenna is set to X₁-X_{N}, and the received data of each array in each range cell is set to rᵢ(xⱼ)(i=1 to L, j=1 to N). In this case, the total number of items of data is N×L, when taking λ for a wavelength of a reception frequency signal, d(d=1 to D) for each number of arrival signal, θ_{d} for an arrival angle of each arrival signal, S for complex amplitude, 0 for an average of each array element, and n for thermal noise vector expressed by distribution σ², the received signal vector rᵢ(xⱼ) in each range cell is expressed by the following Equation (1).

$${r}_{i} = [ \begin{matrix}{r}_{i} ( {x}_{1} ) \\ {r}_{i} ( {x}_{2} ) \\ ⋮ \\ {r}_{i} ( {x}_{N} )\end{matrix} ] = [ \begin{matrix}{e}^{j 2 π \frac{{x}_{1}}{λ} sin {θ}_{1}} & {e}^{j 2 π \frac{{x}_{1}}{λ} sin {θ}_{2}} & … & {e}^{j 2 π \frac{{x}_{1}}{λ} sin {θ}_{D}} \\ {e}^{j 2 π \frac{{x}_{2}}{λ} sin {θ}_{1}} & {e}^{j 2 π \frac{{x}_{1}}{λ} sin {θ}_{2}} & … & {e}^{j 2 π \frac{{x}_{1}}{λ} sin {θ}_{D}} \\ ⋮ & ⋮ & ⋰ & ⋮ \\ {e}^{j 2 π \frac{{x}_{1}}{λ} sin {θ}_{1}} & {e}^{j 2 π \frac{{x}_{1}}{λ} sin {θ}_{2}} & … & {e}^{j 2 π \frac{{x}_{1}}{λ} sin {θ}_{D}}\end{matrix} ] [ \begin{matrix}{s}_{1} \\ ⋮ \\ {s}_{N}\end{matrix} ] + [ \begin{matrix}n ( {x}_{1} ) \\ n ( {x}_{2} ) \\ ⋮ \\ n ( {x}_{N} )\end{matrix} ] \qquad ( 1 )$$

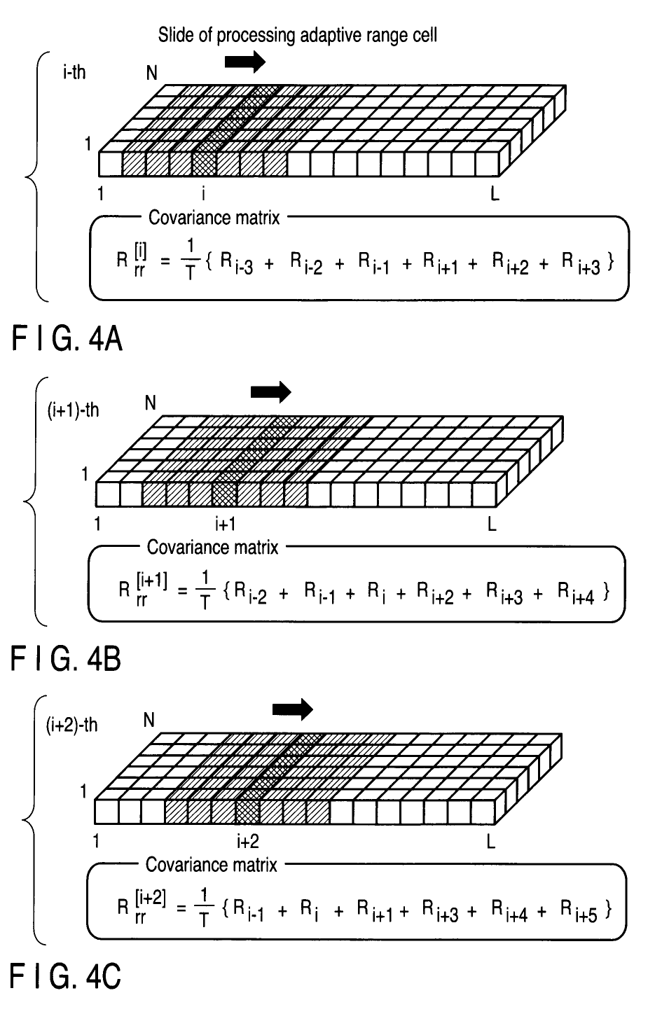

In the conventional sliding window system, when obtaining an undesired signal suppression weight for a k-th (k=1 to L) processing adaptive range cell, it is necessary to derive each covariance matrix of range cells equivalent to the number T of the training samples. In this case, a derivation equation of the covariance matrix is expressed by the following Equation (2).

$${R}_{rr}^{[ i ]} = \frac{1}{T} \{ {r}_{1} {r}_{1}^{H} + , … , + {r}_{i - 1} {r}_{i - 1}^{H} + {r}_{i + 1} {r}_{i + 1}^{H} + {r}_{T} {r}_{T}^{H} \} \qquad ( 2 )$$

Wherein, R^{[i]}ᵣᵣ represents a covariance matrix to be used for weight derivation for the i-th (i=1 to L). FIGS. 4A, 4B and 4C each depict processing images of the sliding windows in the conventional systems. FIGS. 4A, 4B and 4C depict a case of obtaining the i-th covariance matrix, a case of obtaining the (i+1)-th covariance matrix, and a case of obtaining the (i+2)-th covariance matrix, respectively. Here, a case in which the number of training samples is 6 is depicted.

Wherein, in the sliding window system of the invention, the weight calculation method calculates a covariance matrix Rᵢ in the i-th range cell over all the range cells in advance, and stores the information. At this time, the i-th covariance matrix Rᵢ is expressed by the following Equation (3).

Rᵢ=rᵢrᵢ^{H} (3)

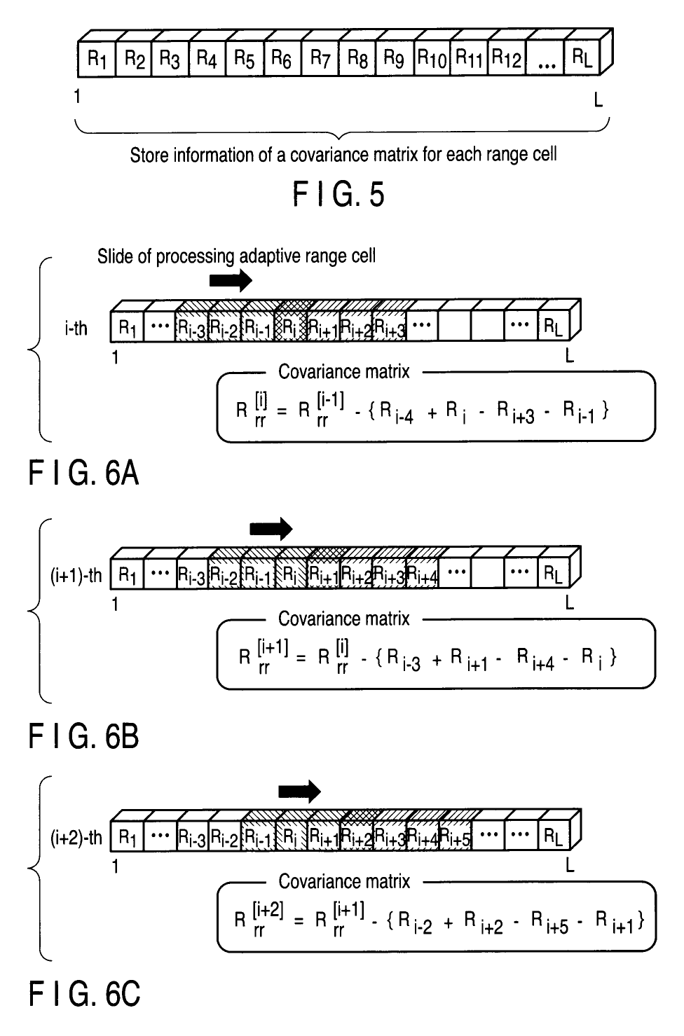

FIG. 5 shows an aspect which stores information R₁-R_{L} of the covariance matrix in each range cell for each range cell corresponding to the information R₁-R_{L}.

To derive a covariance matrix for the i-th processing adaptive range cell, the sliding window in this system generates the covariance matrix from covariance matrices of the number of training samples except for the i-th processing adaptive range cell. To derive a covariance matrix for the (i+1)-th processing adaptive range cell, the sliding window in this system subtracts the covariance matrix of the (i+1)-th processing adaptive range cell from the previously calculated covariance matrix of the i-th processing adaptive range cell, subtracts covariance matrices to be excluded from the training samples from the subtracting result through sliding, adds the covariance matrix of the i-th processing adaptive range cell to the sliding result, and adds covariance matrices to be included in the training samples to the adding result through the sliding.

FIGS. 6A, 6B and 6C each show processing images of the sliding window system of the invention, FIGS. 6A, 6B and 6C depict a case of obtaining the i-th covariance matrix, a case of obtaining the (i+1)-th covariance matrix, and a case of obtaining the (i+2)-th covariance matrix, respectively. In the same manner shown previously, a case in which 6 training samples is assumed. A covariance matrix derivation equation of the sliding window in this system is expressed by the following Equation (4).

Rᵣᵣ^{[i]}=Rᵣᵣ^{[i-1]}−Rᵢ₋₄−Rᵢ+Rᵢ₋₁+Rᵢ₊₃ (4)

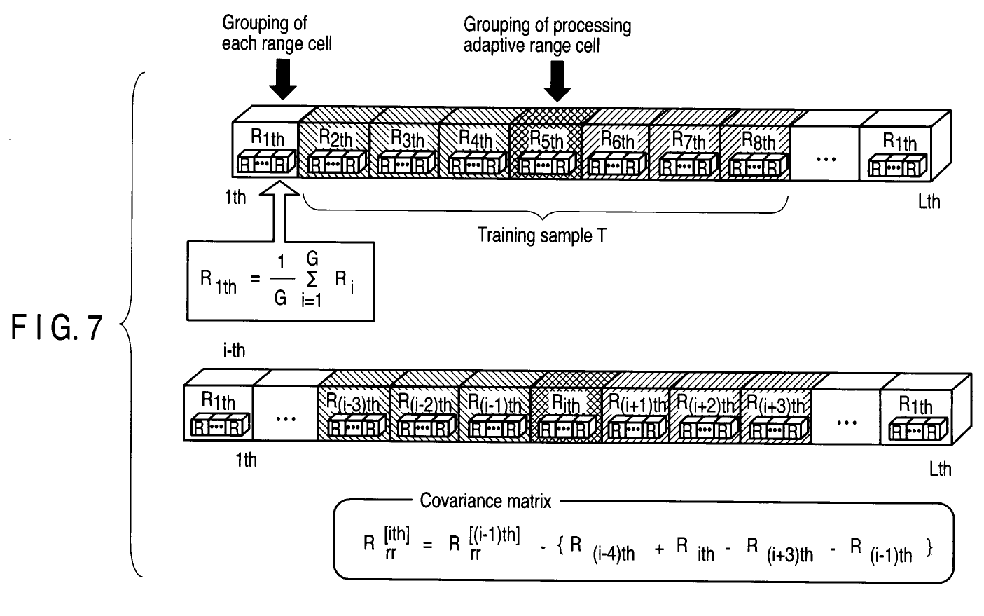

In a case where a plurality of range cells are grouped and assumed as one processing adaptive range cell, the processing image will be illustrated in FIG. 7. FIG. 7 shows a case where the number T of training samples is 6, and the G range cells is gotten together to one range group. The derivation equation of each processing adaptive range cell group is similarly expressed by Equation (4).

The aforementioned processing is executed by means of the covariance matrix computation circuit 141 of the signal processing unit 14 shown in FIG. 1.

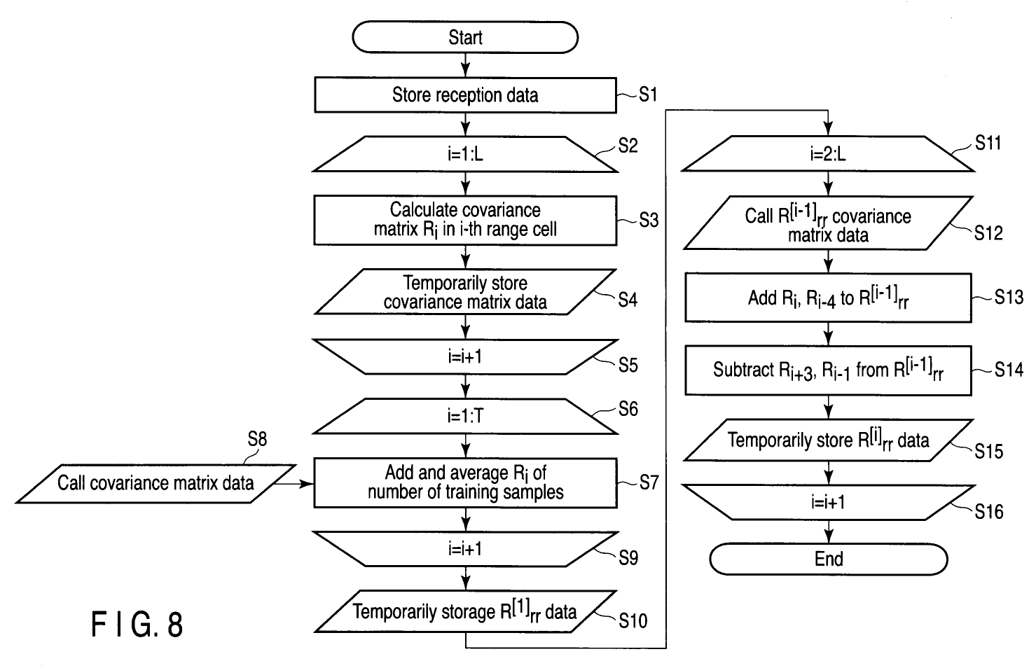

FIG. 8 shows a flowchart depicting a flow of concrete processing by the computation circuit 141. In FIG. 8, the computation circuit 141 firstly monitors a received data storage situation of the data storage unit 13 (Step S1). Calculates the covariance matrix Rᵢ of the i-th range cell until the i reaches T from 1, and temporarily stores the covariance matrix Rᵢ (Steps S2-S5). The computation circuit 141 then calls the covariance matrix data Rᵢ of items of the number of training samples, adds to average the items of the covariance matrix data Rᵢ, and temporarily stores the average of the covariance matrix data R^{[1]}ᵣᵣ (Steps S6-S10). Next, the computation circuit 141 calls the average of the covariance matrix data R^{[i-1]}ᵣᵣ until the i becomes 2 from L, adds Rᵢ to the data R^{[i-1]}ᵣᵣ and Rᵢ₋₄, subtracts Rᵢ₊₃ and Rᵢ₋₁ from the data R^{[i-1]}ᵣᵣ, temporarily stores the resulting R^{[1]}ᵣᵣ data (Steps S11-S16), and terminates a sires of processing.

According to the foregoing processing, since the computation circuit 141 calculates the weight for the next processing adaptive range cell by successively using the covariance matrix data deviated through the weight calculation for the processing adaptive range cell, the amount of computation required to derive the covariance matrix data is drastically reduced in comparison with the conventional system which needs to obtain the covariance matrix of the number of training samples excluding the present processing adaptive range cell, thereby, excellent SINR characteristics can be produced in a short time.

Therefore, according to the weight calculation method and the weight calculation circuit executing the method by means of the aforementioned processing, for weight calculation in order to bring the undesired signal direction for the target reflection signal of the radar pulse to zero, the amount of computation required to derive the covariance matrix may be reduced. The adaptive array antenna and the radar device adopting the weight calculation method may obtain the excellent SINR characteristics to the target in a short time, and shorten the time required to detect the target.

The signal processing unit 14 of the embodiment may further comprise a target shape detection circuit in order to detect the shape of the target. That is, since the amount of computational load can be reduced, even a relatively small-sized computer can be used by incorporating the target shape detection circuit therein.

While the embodiments described above have been described the case of the pulse radar, the invention may applicable to various radar devices using continuous waves and modulated waves.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A weight calculation method for use in a radar device, which stores target reflection signals of radar waves received by an antenna in corresponding cell positions along with received timing to a plurality of processing range cells each having lengths equivalent to prescribed distances on the time axis, and forms a reception combined beam so as to bring direction of arrivals of undesired signal to direction of arrivals of the target reflection signals to zero, and which calculates weights to phase and amplitude of the target reflection signals by means of a sliding window system, comprising:
calculating covariance matrices of received data in all the plurality of processing range cells;
storing the covariance matrices in a memory; and
calculating weights for all the plurality of processing ranges by using the covariance matrices stored in the memory, wherein
the calculating of the covariance matrices comprises:
first processing which derives a covariance matrix to the i-th processing adaptive range cell from covariance matrices of the number of training samples to be excluded the i-th processing adaptive range cell; and
second processing which derives a covariance matrix to the (i+1)-th processing adaptive range cell, by subtracting the covariance matrix to the (i+1)-th processing adaptive range cell from the previously calculated covariance matrix to the i-th processing adaptive range cell, by subtracting covariance matrices to be excluded from the training samples from the subtracting result through sliding, by adding the covariance matrix of the i-th processing adaptive range cell to the subtracting result, and by adding covariance matrices to be included in the training samples to the adding result through the sliding, and
the calculating of the covariance matrices applies the first and second processing to processing adaptive range cells in all the ranges.

2. A weight calculation method for use in a radar device, which stores target reflection signals of radar waves received by an antenna in corresponding cell positions along with received timing to a plurality of processing range cells each having lengths equivalent to prescribed distances on the time axis, and forms a reception combined beam so as to bring direction of arrivals of undesired signal to direction of arrivals of the target reflection signals to zero, and which calculates weights to phase and amplitude of the target reflection signals by means of a sliding window system, comprising:
calculating covariance matrices of received data in all the plurality of processing range cells;
putting a plurality of range cells among all the range cells together as range cell groups;
storing the covariance matrices for each group in a memory; and
calculating weights for all the plurality of processing ranges by using the covariance matrices of each range cell group stored in the memory, wherein
the calculating of the covariance matrices comprises:
first processing which derives a covariance matrix to the i-th processing adaptive range cell group from covariance matrices of the number of training samples to be excluded the i-th processing adaptive range cell group; and
second processing which derives a covariance matrix to the (i+1)-th processing adaptive range cell group, by subtracting the covariance matrix to the (i+1)-th processing adaptive range cell group from the previously calculated covariance matrix to the i-th processing adaptive range cell group, by subtracting covariance matrices to be excluded from the training samples from the subtracting result through sliding, by adding the covariance matrix of the i-th processing adaptive range cell group to the subtracting result, and by adding covariance matrices to be included in the training samples to the adding result through the sliding, and
the calculating of the covariance matrices applies the first and second processing to processing adaptive range cell groups in all the ranges.

3. A weight calculation device comprising:
storage means which stores target reflection signals of radar waves received by an antenna in corresponding cell positions along with received timing to a plurality of processing range cells each having lengths equivalent to prescribed distances on the time axis; and
calculation means which calculates weights to phase and amplitude of the target reflection signals for forming a reception combined beam so as to bring direction of arrivals of undesired signal to direction of arrivals of the target reflection signals to zero by using values stored in the plurality of processing range cells, wherein
the calculation means calculates weights to the phase and the amplitude of the target reflection signals by means of a sliding window system, calculates covariance matrices of received data in all the plurality of processing range cells, stores the covariance matrices in a memory, calculates weights for all the plurality of processing ranges by using the covariance matrices stored in the memory,
the calculating of the covariance matrices comprises:
first processing which derives a covariance matrix to the i-th processing adaptive range cell from covariance matrices of the number of training samples to be excluded the i-th processing adaptive range cell; and
second processing which derives a covariance matrix to the (i+1)-th processing adaptive range cell, by subtracting the covariance matrix to the (i+1)-th processing adaptive range cell from the previously calculated covariance matrix to the i-th processing adaptive range cell, by subtracting covariance matrices to be excluded from the training samples from the subtracting result through sliding, by adding the covariance matrix of the i-th processing adaptive range cell to the subtracting result, and by adding covariance matrices to be included in the training samples to the adding result through the sliding, and
the calculating of the covariance matrices applies the first and second processing to processing adaptive range cells in all the ranges.

4. A weight calculation device comprising:
storage means which stores target reflection signals of radar waves received by an antenna in corresponding cell positions along with received timing to a plurality of processing range cells each having lengths equivalent to prescribed distances on the time axis; and
calculation means which calculates weights to phase and amplitude of the target reflection signals for forming a reception combined beam so as to bring direction of arrivals of undesired signal to direction of arrivals of the target reflection signals to zero by using values stored in the plurality of processing range cells, wherein
the calculation means calculates weights to the phase and the amplitude of the target reflection signals by means of a sliding window system, calculates covariance matrices of received data in all the plurality of processing range cells, puts a plurality of range cells among all the range cells together as range cell groups, stores the covariance matrices for each group in a memory, and calculates weights for all the plurality of processing ranges by using the covariance matrices of each range cell group stored in the memory, and
the calculation of the covariance matrices comprises:
first processing which derives a covariance matrix to the i-th processing adaptive range cell group from covariance matrices of the number of training samples to be excluded the i-th processing adaptive range cell group; and
second processing which derives a covariance matrix to the (i+1)-th processing adaptive range cell group, by subtracting the covariance matrix to the (i+1)-th processing adaptive range cell group from the previously calculated covariance matrix to the i-th processing adaptive range cell group, by subtracting covariance matrices to be excluded from the training samples from the subtracting result through sliding, by adding the covariance matrix of the i-th processing adaptive range cell group to the subtracting result, and by adding covariance matrices to be included in the training samples to the adding result through the sliding, and
the calculating of the covariance matrices applies the first and second processing to processing adaptive range cell groups in all the ranges.

5. An adaptive array antenna which arranges a plurality of element antennas in an array configuration, applies directivity control in arbitrary directions, and receives target reflection signals of radar waves, comprising:
storing the target reflection signals in corresponding cell positions along with received timing to a plurality of processing range cells each having lengths equivalent to prescribed distances on the time axis;
taking in adaptive weights to phase and amplitude of the received target reflection signals so as to bring direction of arrivals of undesired signal to direction of arrivals of the target reflection signals to zero; and
forming a reception combined beam by applying weight control to the target reflection signals, wherein
the adaptive weights are obtained by calculating weights to phase and amplitude of the received target reflection signals through a sliding window system, and are calculated for all the plurality of processing range cells by calculating covariance matrices of received data in all the plurality of processing ranges, by storing the covariance matrices in a memory, and by using the stored covariance matrices, and
the calculating of the covariance matrices comprises:
first processing which derives a covariance matrix to the i-th processing adaptive range cell from covariance matrices of the number of training samples to be excluded the i-th processing adaptive range cell; and
second processing which derives a covariance matrix to the (i+1)-th processing adaptive range cell, by subtracting the covariance matrix to the (i+1)-th processing adaptive range cell from the previously calculated covariance matrix to the i-th processing adaptive range cell, by subtracting covariance matrices to be excluded from the training samples from the subtracting result through sliding, by adding the covariance matrix of the i-th processing adaptive range cell to the subtracting result, and by adding covariance matrices to be included in the training samples to the adding result through the sliding, and
the calculating of the covariance matrices applies the first and second processing to processing adaptive range cells in all the ranges.

6. An adaptive array antenna which arranges a plurality of element antennas in an array configuration, applies directivity control in arbitrary directions, and receives target reflection signals of radar waves, comprising:
storing the target reflection signals in corresponding cell positions along with received timing to a plurality of processing range cells each having lengths equivalent to prescribed distances on the time axis;
taking in adaptive weights to phase and amplitude of the received target reflection signals so as to bring direction of arrivals of undesired signal to direction of arrivals of the target reflection signals to zero;
forming a reception combined beam by applying weight control to the target reflection signals, wherein
the adaptive weights are obtained by calculating weights to phase and amplitude of the received target reflection signals through a sliding window system, and are calculated for all the plurality of processing range cells by calculating covariance matrices of received data in all the plurality of processing ranges, by putting a plurality of range cells among the range cells together as range cell groups, by storing the covariance matrices for each group in a memory, and by using the stored covariance matrices of each range cell group, and
the calculating of the covariance matrices comprises:
first processing which derives a covariance matrix to the i-th processing adaptive range cell group from covariance matrices of the number of training samples to be excluded the i-th processing adaptive range cell group; and
second processing which derives a covariance matrix to the (i+1)-th processing adaptive range cell group, by subtracting the covariance matrix to the (i+1)-th processing adaptive range cell from the previously calculated covariance matrix to the i-th processing adaptive range cell group, by subtracting covariance matrices to be excluded from the training samples from the subtracting result through sliding, by adding the covariance matrix of the i-th processing adaptive range cell to the subtracting result, and by adding covariance matrices to be included in the training samples to the adding result through the sliding, and
the calculating of the covariance matrices applies the first and second processing to processing adaptive range cell groups in all the ranges.

7. A radar device comprising:
an adaptive array antenna which arranges a plurality of element antennas in an array configuration, applies directivity control in arbitrary directions, receives target reflection signals of radar waves, applies weight control to the target reflection signals by given adaptive weights, and forms a reception combined beam;
a weight calculation device which stores the target reflection signals in corresponding cell positions along with received timing to a plurality of processing range cells each having lengths equivalent to prescribed distances on the time axis, and calculates weights to phase and amplitude of the target reflection signals for forming a reception combined beam so as to bring direction of arrivals of undesired signal to direction of arrivals of the target reflection signals to zero, by using values stored in the plurality of processing range cells; and
a signal processing device which detects a target from the target reflection signals to which weight control is applied by the adaptive array antenna, wherein
the weight calculation means comprises:
storage means which stores the target reflection signals of the radar waves received by the adaptive array antenna in corresponding cell positions in a plurality of processing range cells having lengths equivalent to prescribed distances on the time axis; and
calculation means which calculates weights to phase and amplitude of the received target reflection signals for forming a reception combined beam so as to bring direction of arrivals of undesired signal to zero to direction of arrivals of the target reflection signals by using values stored in the plurality of processing range cells, wherein
the calculation means calculates weights to the phase and the amplitude of the target reflection signals by means of a sliding window system, calculates covariance matrices of received data in all the plurality of processing range cells, stores the covariance matrices in a memory, calculates weights for all the plurality of processing ranges by using the covariance matrices stored in the memory,
the calculating of the covariance matrices comprises:
first processing which derives a covariance matrix to the i-th processing adaptive range cell from covariance matrices of the number of training samples to be excluded the i-th processing adaptive range cell; and
second processing which derives a covariance matrix to the (i+1)-th processing adaptive range cell, by subtracting the covariance matrix to the (i+1)-th processing adaptive range cell from the previously calculated covariance matrix to the i-th processing adaptive range cell, by subtracting covariance matrices to be excluded from the training samples from the subtracting result through sliding, by adding the covariance matrix of the i-th processing adaptive range cell to the subtracting result, and by adding covariance matrices to be included in the training samples to the adding result through the sliding, and
the calculating of the covariance matrices applies the first and second processing to processing adaptive range cells in all the ranges.

8. A radar device comprising:
an adaptive array antenna which arranges a plurality of element antennas in an array configuration, applies directivity control in arbitrary directions, receives target reflection signals of radar waves, applies weight control to the target reflection signals by given adaptive weights, and forms a reception combined beam;
a weight calculation device which stores the target reflection signals in corresponding cell positions along with received timing to a plurality of processing range cells each having lengths equivalent to prescribed distances on the time axis, and calculates weights to phase and amplitude of the target reflection signals for forming a reception combined beam so as to bring direction of arrivals of undesired signal to direction of arrivals of the target reflection signals to zero, by using values stored in the plurality of processing range cells; and
a signal processing device which detects a target from the target reflection signals to which weight control is applied by the adaptive array antenna, wherein
the weight calculation means comprises:
storage means which stores the target reflection signals of the radar waves received by the adaptive array antenna in corresponding cell positions to a plurality of processing range cells having lengths equivalent to prescribed distances on the time axis; and
calculation means which calculates weights to phase and amplitude of the received target reflection signals for forming a reception combined beam so as to bring direction of arrivals of undesired signal to zero to direction of arrivals of the target reflection signals by using values stored in the plurality of processing range cells, wherein
the calculation means calculates weights to the phase and the amplitude of the target reflection signals by means of a sliding window system, calculates covariance matrices of received data in all the plurality of processing range cells, puts a plurality of range cells among all the range cells together as range cell groups, stores the covariance matrices for each group in a memory, and calculates weights for all the plurality of processing ranges by using the covariance matrices of each range cell group stored in the memory, and
the calculation of the covariance matrices comprises:
first processing which derives a covariance matrix to the i-th processing adaptive range cell group from covariance matrices of the number of training samples to be excluded the i-th processing adaptive range cell group; and
second processing which derives a covariance matrix to the (i+1)-th processing adaptive range cell group, by subtracting the covariance matrix to the (i+1)-th processing adaptive range cell group from the previously calculated covariance matrix to the i-th processing adaptive range cell group, by subtracting covariance matrices to be excluded from the training samples from the subtracting result through sliding, by adding the covariance matrix of the i-th processing adaptive range cell group to the subtracting result, and by adding covariance matrices to be included in the training samples to the adding result through the sliding, and
the calculating of the covariance matrices applies the first and second processing to processing adaptive range cells in all the ranges.
